(19) United States
(12) Patent Application Publication
(10) Pub. No.: US 2006/0098021 A1
(43) Pub. Date: May 11, 2006

(54) Graphics system and memory device for three-dimensional graphics acceleration and method for three dimensional graphics processing

(75) Inventors: Jung-Hwan Rim, Seongnam-si (KR); Tack Don Han, Seoul (KR); Kyung-Ho Kim, Seongnam-si (KR); Joo-Kwang Kim, Yongin-si (KR); Sung-Soo Byeon, Anyang-si (KR); Il-San Kim, Seoul (KR); Woo-Chan Park, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/268,575

(22) Filed: Nov. 8, 2005

(30) Foreign Application Priority Data
Nov. 11, 2004 (KR) 91939/2004

(51) Int. Cl. G06F 12/02

(52) U.S. Cl. 345/543

(57) ABSTRACT

A graphics system and a memory device for three-dimensional (3D) graphics acceleration, and a method for 3D graphics processing, are provided. In a memory device in a graphics system for 3D graphics processing, a memory structure includes a first memory area allocated to a texture buffer for storing texture data, and a second memory area allocated to a frame buffer for storing frame data in pixels. A comparator controls the memory structure to operate as the texture buffer if an input address to the memory structure indicates the first memory area and controls the memory structure to operate as the frame buffer if the input address indicates the second memory area. If the memory structure operates as the frame buffer, an ALU performs depth comparison or alpha-blending on input frame data and frame data read from the frame buffer.

### CROSS-REFERENCE TO RELATED APPLICATION

This application claims the benefit under 35 U.S.C. § 119 from Korean Patent Application No. 2004-91939, filed on Nov. 11, 2004 in Korean Intellectual Property Office, the entire disclosure of which is hereby incorporated by reference.

### BACKGROUND OF THE INVENTION

1. Field of the Invention

The present invention relates generally to a computer graphics system. In particular, the present invention relates to a graphics system and a memory device for effectively processing three-dimensional (3D) graphic compressed texture data in mobile phone applications, and to a method for 3D graphics processing.

2. Description of the Related Art

3D graphics processing is broken up into two major stages: geometry processing and rasterization. In geometry processing, the vertices that make up polygons of graphic forms, such as triangles, are transformed according to a viewing point. The color is computed for each vertex according to a predetermined lighting model. Rasterization is the process of converting the geometry-processed triangles into final pixels and carrying out texture mapping, depth comparison, and alpha-blending on the pixels.

3D graphics processing is composed, at least in part, of many independent operations. One conventional technique for performing these operations in parallel is pipelining. According to the technique of pipelining, individual processors are serially connected. After a series of operations for one data, a first processor provides the processed data to a second processor responsible for other operations. At the same time, the first processor performs the operations on another data. A 3D graphics system is built with pipelines for texture mapping, depth comparison, and alpha-blending, to thereby improve processing efficiency.

A 3D graphics accelerator co-developed by SUN™ and Mitsubishi™ uses a 3D random access memory (RAM) which is a graphics memory with a Z-test pipeline and an alpha-blending pipeline built therein. In the 3D graphics accelerator, depth comparison and alpha-blending are carried out in the 3D RAM, not in a 3D graphics processor. Without the 3D RAM, the depth comparison and the alpha-blending require a read-modify-write operation, whereas with the 3D RAM, a write-only operation suffices. Therefore, the use of the 3D RAM reduces a bandwidth requirement between a graphics processor and a frame buffer, and increases performance.

A conventional fast memory, synchronous dynamic RAM (SDRAM) is suitable for consecutive read and write operations for one block of burst data, while conventional 3D RAM uses an internal cache and a pre-fetch technique in order to improve performance through processing of successive pixels. Therefore, the use of 3D RAM requires separately procured hardware, complicates control, and causes performance degradation due to a cache miss.

Another drawback with 3D RAM is that, although 3D RAM is designed to store frame data in pixels and process depth comparison and alpha-blending effectively, text storing or a stencil buffer are neglected in the configuration of 3D RAM. At the time when 3D RAM was developed, a dedicated memory system was generally used in which a frame buffer and a texture memory were separately procured. Developments in memory technology have enabled most of the current graphics memory systems to use a unified memory system in which a texture memory, a stencil memory, and a frame buffer exist together to store data associated with graphics processing. In this context, if a memory having 3D RAM functionality is designed with the current memory technology, a texture memory and a frame buffer must reside in a single chip. However, because 3D RAM operates very differently with the texture memory, an effective architecture is difficult to realize.

### SUMMARY OF THE INVENTION

An exemplary object of the present invention is to address at least the above problems and/or disadvantages. Accordingly, an exemplary object of the present invention is to provide a 3D graphics processing method and apparatus, and a method for 3D graphics processing, for rapidly performing depth comparison and alpha-blending on burst data of consecutive pixels.

Another exemplary object of the present invention is to provide a graphics DRAM structure for providing a unified memory system in which frame data and texture data reside in the same memory space, and an operation method thereof.

The above exemplary objects of the present invention are achieved by providing a graphics system and a memory device for 3D graphics acceleration, and a method for 3D graphics processing.

According to an exemplary aspect of the present invention, in a memory device in a graphics system for 3D graphics processing, a memory structure includes a first memory area allocated to a texture buffer for storing texture data, and a second memory area allocated to a frame buffer for storing frame data in pixels. A comparator controls the memory structure to operate as the texture buffer if an input address to the memory structure indicates the first memory area and controls the memory structure to operate as the frame buffer if the input address indicates the second memory area. If the memory structure operates as the frame buffer, an arithmetic-logic unit (ALU) performs depth comparison or alpha-blending on input frame data and frame data read from the frame buffer.

According to another exemplary aspect of the present invention, in a graphics system for 3D graphics processing, a graphics processor receives fragment information for processing a 3D object and performs texture mapping on the fragment information. At least one pair of memory devices store texture data referenced for the texture mapping, storing frame data in pixels, and perform depth comparison and alpha-blending on the frame data.

### BRIEF DESCRIPTION OF THE DRAWINGS

The above and other exemplary objects, features and advantages of the exemplary embodiments of the present invention will become more apparent from the following detailed description of the exemplary embodiments, taken in conjunction with the accompanying drawings in which like reference symbols indicate the same or similar components, wherein:

FIG. 1 illustrates a 3D object to which an exemplary implementation of the present invention is applied;

FIG. 2 is a block diagram of a computer system according to an exemplary embodiment of the present invention;

FIG. 3 is a detailed block diagram of a graphics system according to an exemplary embodiment of the present invention as illustrated in FIG. 2;

FIG. 4 is a conceptual view of a pixel rasterization pipeline according to an exemplary embodiment of the present invention;

FIG. 5 is a block diagram of a frame buffer having a Z-test pipeline and an alpha-blending pipeline built therein according to an exemplary embodiment of the present invention;

FIG. 6 illustrates an exemplary structure of a graphics system having a plurality of 3D RAMs, for depth comparison and alpha-blending;

FIG. 7 is a block diagram of a graphics memory according to an exemplary embodiment of the present invention; and

FIG. 8 illustrates an exemplary structure of a graphics system having a 3D graphics processor with a 256-bit bus, and SDRAMs.

### DETAILED DESCRIPTION OF EXEMPLARY EMBODIMENTS

Exemplary embodiments of the present invention will be described herein below with reference to the accompanying drawings. In the following description, well-known functions or constructions are not described in detail for conciseness.

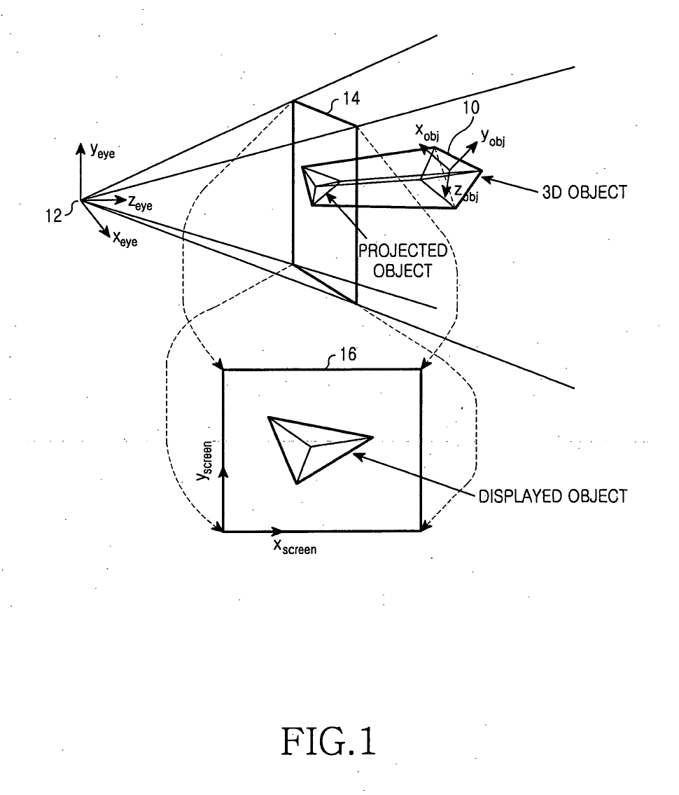

FIG. 1 illustrates a 3D object to which an embodiment of the present invention can be applied.

Referring to FIG. 1, an object 10 in 3D space is a tetrahedron with its own coordinate axes (x_{obj}, y_{obj}, and z_{obj}). This object 10 is translated, scaled, and placed in the coordinate system of a viewing point 12 based on coordinate axes (x_{eye}, y_{eye}, and z_{eye}). The object 10 is projected onto a viewing plane 14 according to perspective scaling so that it appears two-dimensional. The z-coordinates of the object 12 are preserved for future use. The object 10 is finally translated into screen coordinates based on coordinate axes (x_{screen, y}_{screen}, and z_{screen}) on a display screen 16. Points on the object 10 now have their x and y coordinates described by pixel locations on the display screen 16 and their z-coordinates in a scaled version of distance from the viewing point 12.

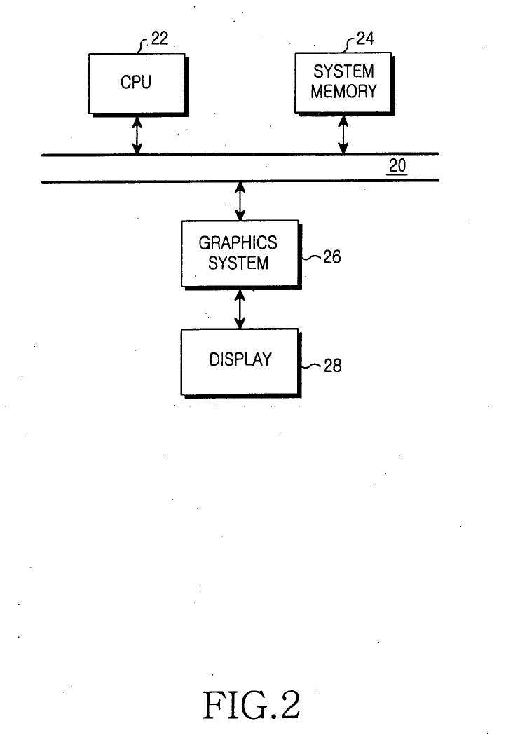

FIG. 2 is a block diagram of a computer system according to an exemplary embodiment of the present invention.

Referring to FIG. 2, the computer system includes a central processing unit (CPU) 22 connected to a system bus (fast memory bus or host bus) 20. A system memory 24 communicates with the CPU 22 via the system bus 20. The CPU 22 may include one or more processors, and the system memory 24 can be a combination of various memories. A graphics system 26 may have a communication port for receiving graphic data from the system memory 24 via the system bus 20 or receiving graphic data directly from an external source such as the Internet or a network. The graphic data is processed in the graphics system 26 and then output to at least one display 28 connected to the graphics system 26.

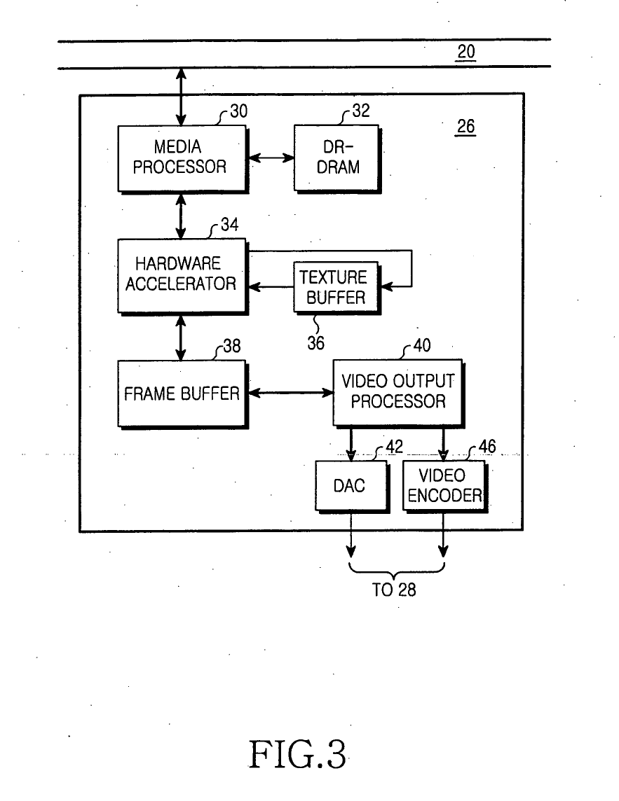

FIG. 3 is a detailed block diagram of the graphics system 26 illustrated in FIG. 2.

Referring to FIG. 3, the graphics system 26 is comprised of at least one media processor 30, at least one hardware accelerator 34, at least one texture buffer 36, at least one frame buffer 38, and at least one video output processor 40. It further includes a digital-to-analog converter (DAC) 42, a video encoder 46, and a display driver (not shown) which are connected to the display 28. The media processor 30 and the hardware accelerator 34 may reside in different integrated circuits (ICs) or in the same IC.

The graphics system 26 having the above-described configuration is enabled in response to a command from the CPU 22 via the system bus 20. The media processor 30 interprets the command and interfaces between the CPU 22 and the graphics system 26. The media processor 30 can also perform typical processing on graphics data, such as transformation and lighting. Programs and data for the media processor 30 are stored in, for example, a Direct Rambus (DR) DRAM 32.

The hardware accelerator 34 receives the graphics data from the media processor 30 and performs a number of functions on the graphics data, including rasterization, 3D texturing, pixel transfers, imaging, fragment processing, clipping, depth cueing, transparency processing, and rendering. The hardware accelerator 34 reads/writes graphics data from/to the frame buffer 38 and reads texel data from the text buffer 36. A texel refers to a smallest graphic unit in a texture mapping image of a 3D object.

For one of the 3D graphics processes, namely rasterization, the hardware accelerator 34 is configured in a pipeline structure. Thus, it includes a texture mapping pipeline, a Z-test pipeline, and an alpha-blending pipeline.

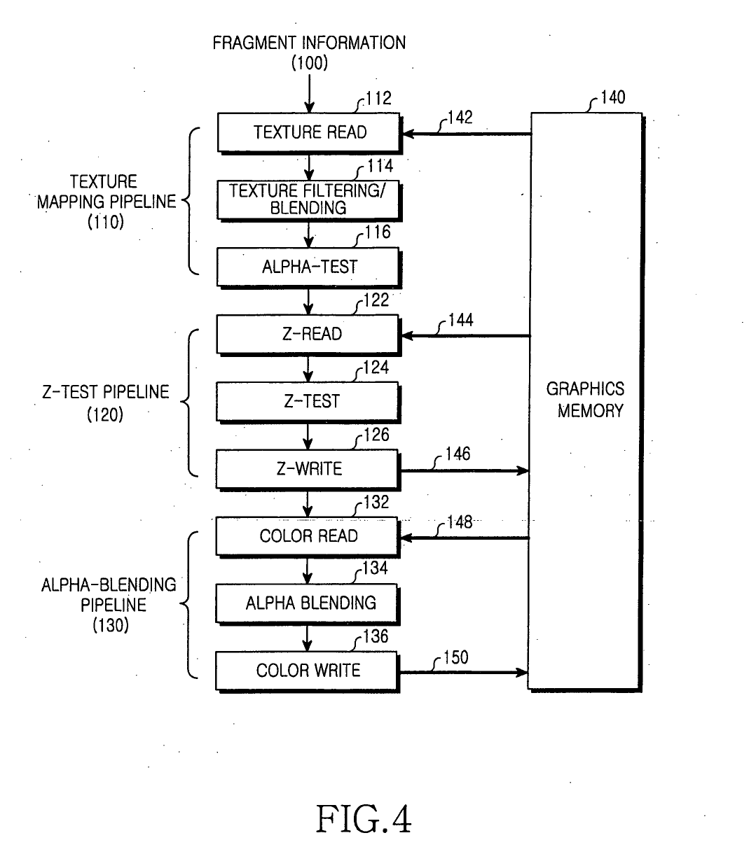

FIG. 4 is a conceptual view of a pixel rasterization pipeline according to an exemplary embodiment of the present invention. In FIG. 4, a graphics memory 140 includes a texture buffer and a frame buffer, and the frame buffer has a depth buffer and a color buffer.

Referring to FIG. 4, input fragment information includes information about the colors, 3D position coordinates (x, y, z), and texture coordinates of pixels generated by interpolation. The colors are defined by four colors, read (R), green (G), blue (B), and alpha (A). For example, a color is represented by 32 bits, 8 bits for each color element. Here, alpha denotes the transparency of a pixel. If alpha is 8 bits, alpha level 0 means 100% transparent and alpha level 255 means opaque. An alpha level is used to blend a transparent image such as a glass form or text with a background. This process is called “alpha-blending”.

A texture mapping pipeline 110 reads four or eight texels 142 for corresponding texture coordinates from the graphics memory 140 (step 112) and performs texture filtering and blending on the texels (step 114). As noted above, a texel refers to a smallest graphic unit in a texture mapping image of a 3D object.

The resulting texel is blended with a pixel color set in the fragment information, thereby producing an alpha value. An alpha test (step 116) is performed by comparing the alpha value of a given pixel with a reference alpha value. The comparison can be made based on many criteria. For example, if the pixel alpha value is higher than the reference alpha value, the alpha test passes. According to another example, if the pixel alpha value is lower than the reference alpha value, the alpha test passes. The alpha test is carried out fragment by fragment. Therefore, if all pixels associated with the fragment information pass the alpha test, the procedure goes to the next pipeline step 120. If the alpha test fails, the fragment is dropped out from the pipeline.

The depth comparison and alpha-blending follow the texture mapping pipeline 110.

In the Z-test pipeline 120, a Z-value 144 is read from the graphics memory 140 (step 122) and compared with that of the current fragment in a depth test or a Z-test (step 124). The Z-test 124 can be carried out in different ways. For example, if the Z-value 144 is greater than, less than, equal to or greater than, or equal to or less than that of the current fragment, the Z-test 124 passes.

If the Z-test 124 fails, that is, if the current fragment is obscured by the previously drawn pixel, the current fragment is removed from the pipeline 120. Otherwise, the Z-value 146 of the current fragment is written in the depth buffer of the graphics memory 140 (step 126).

In the alpha-blending pipeline 130, a color value 148 is read from the graphics memory 140 (step 132) and alpha-blended with the result of texture blending (step 134). The final color value 150 is written into the color buffer of the graphics memory 140 (step 150). The alpha-blending includes combining the color value RGBA of the current fragment with the read color value RGBA.

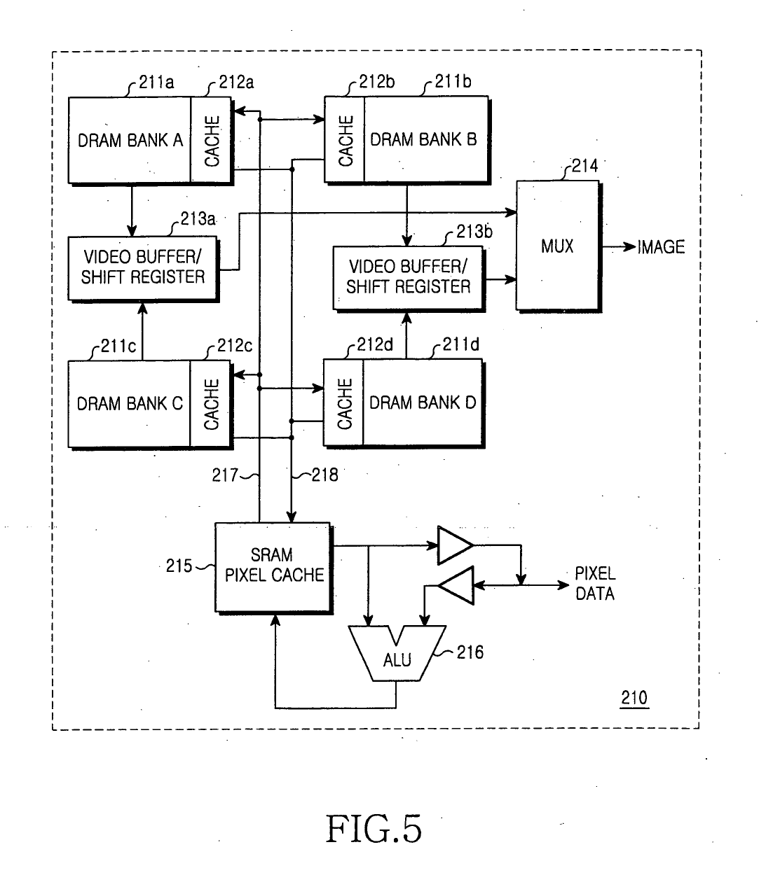

As described above, the pipelines for graphics processing access the buffers of the graphics memory 140, that is, the texture buffer and the frame buffer with the depth buffer and the color buffer. FIG. 5 is a block diagram of a frame buffer which is a graphics memory having a Z-test pipeline and an alpha-blending pipeline built therein according to an exemplary embodiment of the present invention. The frame buffer is configured with at least one 3D RAM.

Referring to FIG. 5, the total storage capacity of a 3D RAM 210 is equally distributed to four DRAM banks 211a to 211d (DRAM bank A to DRAM bank D) that form a depth buffer or a color buffer. Each DRAM bank is divided into a plurality of pages. A page is a minimum data unit that is directly accessible. Every DRAM bank forms a page group according to a page address. The DRAM banks 211a to 211d include level-2 caches 212a to 212d. The caches 212a to 212d are of a size enough to preserve one page of data. They can be called page buffers.

A write bus 217 and a read bus 218 have a capacity to transfer the entire pixels of one block of a predetermined size. They transfer pixel data between the caches 212a to 212d and a 2K-bit static RAM (SRAM) pixel cache 215 that can store the burst pixel data of a plurality of blocks. The pixel cache 215 can be configured as a level-1 cache memory that stores one block of pixel data in each cache tag entry, unlike the caches 212a to 212d. Each pixel block in the pixel cache 215 corresponds to the data stored in one DRAM bank. The pixel cache 215 has a dedicated port for connection to an arithmetic-logic unit (ALU) 216 as well as two ports for input/output from/to the caches 212a to 212d. The pixel cache 215 functions to match the different speeds of the fast operating ALU 216 and the DRAM banks 211.

The ALU 216 receives inbound pixel data from an external circuit outside the 3D RAM 210 as one operand. It fetches another operand from the pixel cache 215. The ALU 216 is implemented with many mathematical functions needed for data combining or blending. In particular, the ALU 216 renders the 3D RAM 210 to perform write-only operations instead of read-modify-write operations in Z-test or alpha-blending.

The 3D RAM 210 is further provided with two video buffers/shifter registers 213a and 213b. The buffer/shifter registers buffer parallel inputs from each of the DRAM banks and convert them to a serial output to a multiplexer (MUX) 214. The MUX 214 multiplexes the serial pixel streams received from the shift registers into image output.

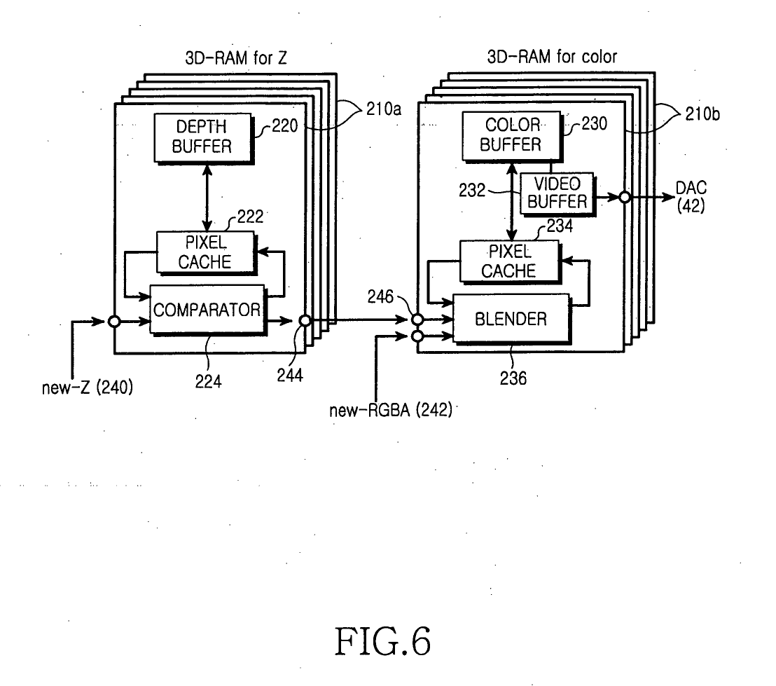

FIG. 6 illustrates the structure of a graphics system having a plurality of 3D RAMs, for depth comparison and alpha-blending. In the illustrated case, 3D RAMs 210a and 210b each process 32-bit pixel data, by way of example.

Referring to FIG. 6, each of four 3D RAMs 210a for depth processing is comprised of a DRAM 220 serving as a depth buffer, a pixel cache 222, and an ALU 224 as a comparator for depth comparison. Each of four 3D RAMs 210b includes a DRAM 230 as a color buffer, a video buffer 232, a pixel cache 234, and an ALU 236 as a blender for alpha-blending.

A new-Z value 240 and a new-RGBA value 242 are generated in a 3D graphics processor (not shown) and provided to a 3D RAM for Z 210a and a 3D RAM for color 210b in synchronization to a 100-MHz read-only clock signal. In the 3D RAM for Z 210a, the comparator 224 compares the new-Z value 240 with a Z-value read from the depth buffer 220 via the pixel cache 222 and provides the depth comparison result to the 3D RAM for color 210b via a pass_out pin 244 and a pass_in pin 246. If the z-test passes, the new-Z value 240 is written into the depth buffer 220 via the pixel cache 222.

In the 3D RAM for color 210b, the blender 236 alpha-blends the new-RGBA value 242 with a color value read from the color buffer 230 via the pixel cache 234. The final color value is written into the color buffer 230 via the pixel cache 234. Upon completion of graphics processing of one block of burst pixel data, the pixel value written in the color buffer 230 is provided to a RAM digital-to-analog converter (RAMDAC) 42 via the video buffer 323.

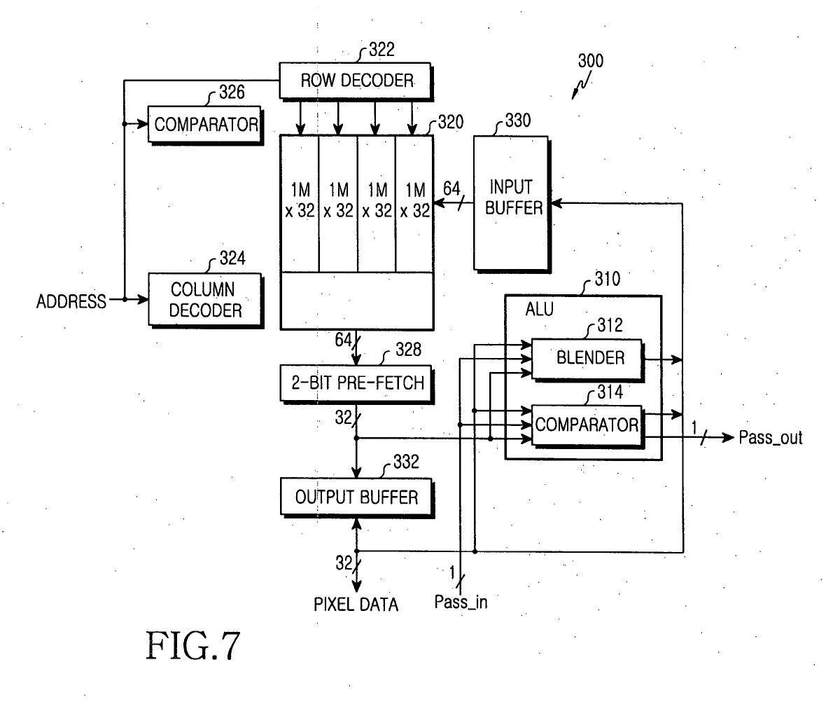

FIG. 7 is a block diagram of a graphics memory according to an exemplary embodiment of the present invention. As illustrated, an ALU 310 and a comparator 326 are embedded in a 128M double data rate (DDR) SDRAM memory used for graphics processing.

Referring to FIG. 7, a DRAM 320 stores both frame data and texture data which are referred to on a 64-bit basis and transmitted on a 32-bit basis. The DDR SDRAM memory includes a row decoder 322, a column decoder 324, an input buffer 330, a 2-bit pre-fetch 328, and an output buffer 332. The ALU 310 includes a comparator 314 and a blender 312.

The row decoder 322 receives a row address and activates the memory area of the DRAM 320 corresponding to the row address. The column decoder 324 receives a column address and activates a bit position corresponding to the column address in the DRAM 320. The pre-fetch 328 reads data from the DRAM 320 in each address cycle and provides the data to the output buffer 332, so that data can be accessed several times faster than the clock speed of the DRAM 320. In the illustrated exemplary memory structure, burst pixel data is read and written alternately, thereby obviating the need for a cache memory.

A texture buffer and a frame buffer may reside in different memory areas on the same chip in the DRAM 320. The comparator 326 determines whether an input address refers to frame data or texture data by checking the input address provided to the row decoder 322. For example, in the case where the texture data is allocated to an upper memory area in the DRAM 320, if predetermined upper bits of the input address are all 0s, the comparator 326 determines that the input address refers to texture data, and the DRAM 320 allows the 3D graphics processor to read the texture data. On the other hand, if the input address refers to frame data for depth comparison and alpha-blending, the ALU 310 performs depth comparison and alpha-blending.

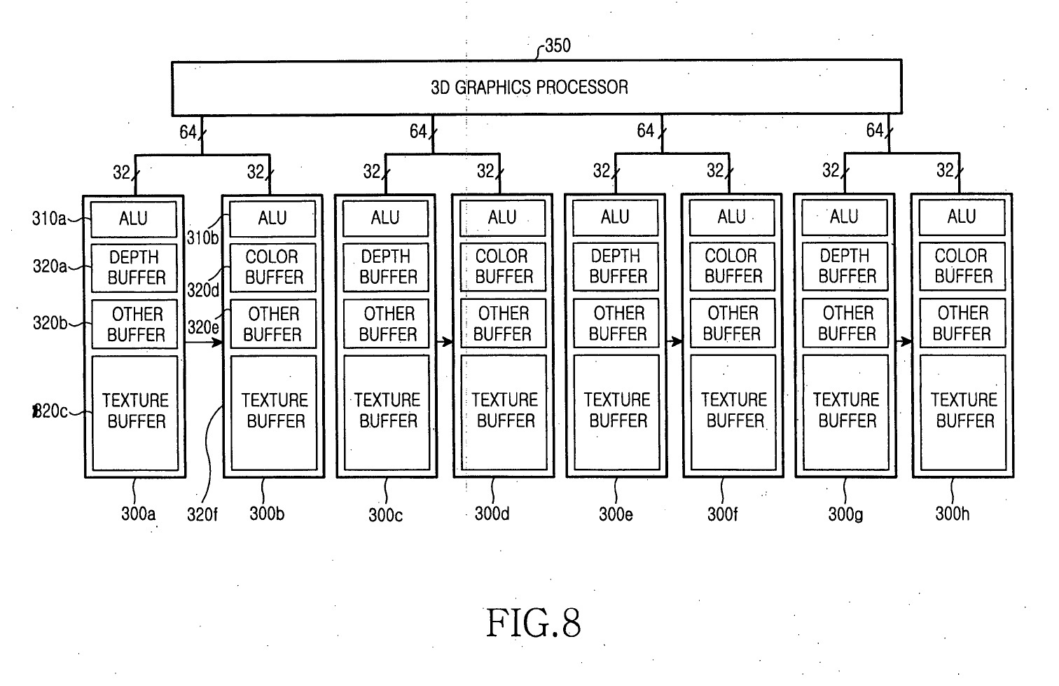

A graphics system according to an exemplary embodiment of the present invention can be configured with a plurality of DDR SDRAMs illustrated in FIG. 7. FIG. 8 illustrates the structure of a graphics system having a 3D graphics processor with a 256-bit bus, and SDRAMs. In FIG. 8, eight DDR SDRAMs 300a to 300h each for processing 32-bit burst pixel data are shown. They are implemented on their respective memory chips.

Referring to FIG. 8, each memory chip has ALUs 310a and 310b, frame buffers 320a and 320d, texture buffers 320c and 320f, and other buffers 320b and 320e. The buffers 320b and 320e can be used as stencil buffers or additional color buffers. Similarly to the configuration illustrated in FIG. 6, the memory chips 300a, 300c, 300e and 300g including the depth buffers 320a are paired with the memory chips 300b, 300d, 300f and 300h including the color buffers 320d. Thus, four pairs of memory chips are shown.

A 3D graphics processor 350 provides 256-bit pixel data including four pairs of a 32-bit Z-value and a 32-bit color value to the depth buffers 310a and the color buffers 310b in the eight memory chips 300a to 300h. The memory chips 300a to 300h can receive the next 256 bits directly without the suspension of pipeline operation. Upon input of fragment information with Z-values and color values, the 3D graphics processor 350 reads texture data from the texture buffers 320c and 320f of the memory chips 300a to 300h and performs texture mapping on the color values using the texture data.

The depth comparison result of the ALU 310a in the memory chip for Z 300a is output to the memory chip 300b via a pass_out pin. The memory chip for color 300b receives the depth comparison result via a pass_in pin and performs alpha-blending on a 32-bit color value read from the color buffer 320d.

To be more specific, the ALU 310a in the memory chip for Z 300a compares an input 32-bit Z-value with a 32-bit Z-value read from the depth buffer 320a. If the Z-test passes, the input Z-value is written in the depth buffer 320a and a pass signal is output through the pass_out pin. If the Z-test fails, a failure signal is output through the pass_out pin. The pass_out pin is connected to the pass_in pin of the memory chip for color 300b.

The ALU 310b in the memory chip for color 300b alpha-blends an input 32-bit color value with a 32-bit color value read from the color buffer 320d. If the pass_in signal indicates pass, the ALU 310b stores the alpha-blended value in the color buffer 320d. If the pass_in signal indicates fail, the ALU 310b discards the alpha-blended value.

Since the Z-test and alpha-bending are performed on burst data, the speed of externally input data can be matched to a memory reference. Therefore, the ALUs 310a and 310b can operate without the suspension of pipeline operation.

For example, assuming that burst data requires depth comparison and alpha-blending taking processing time k and a setup latency needed to write after reading the burst data is m cycles, each pipeline stage needs (k+m) time for processing. Because the pipeline operation proceeds for the next pixel data for the m cycles, the latency m does not cause the suspension of the pipeline operation. That is, a 32-bit pixel value is output from one pipeline stage (k+m) cycles later and the writing operation of the burst data immediately follows. Therefore, no more than (2k+m) cycles are required for depth comparison and alpha-blending of one burst data.

In accordance with exemplary embodiments of the present invention as described above, because a frame memory and a texture memory reside in one address space, a cost-effective, efficient unified memory system can be realized. That is, since, for example, burst data with a plurality of pixels are subject to depth comparison and alpha-bending at one time, exemplary implementations of the present invention are suitable for fast DRAM technology. In addition, according to an exemplary implementation of the present invention an internal cache is not needed, thereby reducing hardware and improving performance.

While only a few exemplary implementations of the present invention have been shown and described with reference to certain embodiments thereof, it will be understood by those skilled in the art that various changes and modification may be made without departing from the spirit and scope of the invention as defined by the appended claims.

1. A memory device in a graphics system for three-dimensional (3D) graphics processing, the memory device comprising:
a memory comprising a first memory area allocated to a texture buffer for storing texture data and a second memory area allocated to a frame buffer for storing frame data;
a comparator for controlling the memory to operate as the texture buffer if an input address to the memory indicates the first memory area and for controlling the memory structure to operate as the frame buffer if the input address indicates the second memory area; and
an arithmetic-logic unit (ALU) for, if the memory operates as the frame buffer, performing depth comparison or alpha-blending on input frame data and the frame data read from the frame buffer.

2. The memory device of claim 1, wherein the memory comprises double data rate (DDR) synchronous dynamic random access memory (SDRAM).

3. The memory device of claim 1, wherein the frame buffer comprises:
a depth buffer for storing depth values of the fame data; and
a color buffer for storing color values of the frame data.

4. The memory device of claim 1, wherein the memory comprises:
a DRAM comprising the first and second memory areas;
a row decoder for activating a memory area corresponding to an input row address in the DRAM;
a column decoder for activating a bit position corresponding to an input column address in the DRAM;
an input buffer for buffering data input to the DRAM;
an output buffer for buffering data output from the DRAM; and
a pre-fetch between the DRAM and the output buffer.

5. The memory device of claim 4, wherein the ALU receives the frame data from the pre-fetch and stores the depth-compared or alpha-blended data in the DRAM via the input buffer.

6. A graphics system for three-dimensional (3D) graphics processing, the graphics system comprising:
a graphics processor for receiving fragment information for processing a 3D object and performing texture mapping on the fragment information; and
at least a first and second memory devices for storing texture data for the texture mapping, storing frame data, and performing depth comparison and alpha-blending on the frame data.

7. The graphics system of claim 6, wherein each of the first and second memory devices comprises:
a memory comprising a first memory area allocated to a texture buffer for storing texture data, and a second memory area allocated to a frame buffer for storing the frame data;
a comparator for controlling the memory to operate as the texture buffer if an input address to the memory indicates the first memory area and for controlling the memory to operate as the frame buffer if the input address indicates the second memory area; and
an arithmetic-logic unit (ALU) for, if the memory operates as the frame buffer, performing depth comparison or alpha-blending on input frame data and frame data read from the frame buffer.

8. The graphics system of claim 7, wherein the memory comprises double data rate (DDR) synchronous dynamic random access memory (SDRAM).

9. The graphics system of claim 7, wherein the frame buffer comprises:
a depth buffer for storing depth values of the fame data; and
a color buffer for storing color values of the frame data.

10. The graphics system of claim 7, wherein the memory comprises:
a DRAM comprising the first and second memory areas;
a row decoder for activating a memory area corresponding to an input row address in the DRAM;
a column decoder for activating a bit position corresponding to an input column address in the DRAM;
an input buffer for buffering data input to the DRAM;
an output buffer for buffering data output from the DRAM; and
a pre-fetch between the DRAM and the output buffer.

11. The graphics system of claim 10, wherein the ALU receives the frame data from the pre-fetch and stores the depth-compared or alpha-blended data in the DRAM via the input buffer.

12. The memory device of claim 1, wherein the frame data comprises frame data stored in pixels.

13. The graphic system of claim 6, wherein the frame data comprises frame data stored in pixels.

14. The graphics system of claim 6, comprising at least one pair of memory devices, wherein the at least one pair of memory devices comprises the first and the second memory devices.

15. A method for three-dimensional (3D) graphics processing, the method comprising:
receiving fragment information for processing a 3D object;
performing texture mapping on the fragment information; and
storing texture data for the texture mapping and frame data in at least a first and second memory devices;
performing depth comparison in at least the first and second memory devices; and
performing alpha-blending on the frame data in at least the first and second memory devices.

16. The method of claim 15, wherein the storing of the texture data and the frame data and the performing of the depth comparison and the alpha-blending comprises:
allocating a first memory area to a texture buffer for storing texture data in at least one of the first and second memory devices;
allocating a second memory area to a frame buffer for storing the frame data in at least one of the first and second memory devices;
controlling the memory to operate as the texture buffer if an input address to the memory indicates the first memory area; and
controlling the memory to operate as the frame buffer if the input address indicates the second memory area.

17. The method of claim 16, further comprising, if the memory operates as the frame buffer, performing depth comparison or alpha-blending on input frame data and frame data read from the frame buffer.

18. The method of claim 16, wherein the memory comprises a DRAM, the method comprising:
activating a memory area corresponding to an input row address in the DRAM;
activating a bit position corresponding to an input column address in the DRAM;
buffering data input to the DRAM; and
buffering data output from the DRAM.
